(19) United States
(12) Patent Application Publication
(10) Pub. No.: US 2011/0309227 A1
(43) Pub. Date: Dec. 22, 2011

(54) LOCKING DEVICE FOR LOCKING AN OBJECT ON A SUPPORT STRUCTURE

(76) Inventors: Neal Marshall, West Midlands (GB); Brian Richard Hallett, Essex (GB)

(21) Appl. No.: 13/138,077

(22) PCT Filed: Jan. 5, 2010
(86) PCT No.: PCT/GB2010/000005

§ 371 Date: Jul. 1, 2011

(30) Foreign Application Priority Data
Jan. 5, 2009 (GB) 0900106.6

(51) Int. Cl. F16M 13/00; F16F 1/00

(52) U.S. Cl. 248/560; 248/274.1; 248/295.11

(57) ABSTRACT

A locking device (2) for locking an object (4) on a support structure (6), which locking device (2) comprises a fork arrangement (8) for engaging the object (4), first locking means (10) for locking the fork arrangement (8) to the Object (4) in a horizontal plane, second locking means (12) for locking the fork arrangement (8) to the object (4) in a vertical plane, and movement-permitting means (14) which permits vertical movement in the locking device (2), the vertical movement being sufficient to allow the support structure (6) to flex so as to prevent the flexing of the support structure (6) acting through the locking device (2) and damaging the object (4), but with the vertical movement being insufficient adversely to affect secure locking of the object (4) on the support structure (6) by the locking device (2).

This invention relates to a locking device and, more especially, this invention relates to a locking device for locking an object on a support structure. The locking device may be especially useful for locking cargo on a support structure in the form of a flat platform on a vehicle.

Locking devices are known for locking an object on a support structure. The locking devices are such that the object is rigidly fixed to the support structure. There may be times when the support structure flexes, for example on occasions when the support structure is a wheeled vehicle travelling over rough terrain. This flexing of the support structure may cause forces to be transferred through the locking device and onto the object, with the result that the object may become damaged either instantly or over a period of time due to repeated flexing of the support structure.

It is an aim of the present invention to obviate or reduce the above mentioned problem.

Accordingly, in one non-limiting embodiment of the present invention there is provided a locking device for locking an object on a support structure, which locking device comprises a fork arrangement for engaging the object, first locking means for locking the fork arrangement to the object in a horizontal plane, second locking means for locking the fork arrangement to the object in a vertical plane, and movement-permitting means which permits vertical movement in the locking device, the vertical movement being sufficient to allow the support structure to flex so as to prevent the flexing of the support structure acting through the locking device and damaging the object, but with the vertical movement being insufficient adversely to affect secure locking of the object on the support structure by the locking device.

During normal conditions, the support structure will not be caused to flex and the locking device will rigidly lock the object on the support structure. However, if conditions should occur in which the support structure is caused to flex, then the provision of the movement-permitting means permits the flexing to take place without damaging the object and also without compromising the secure locking of the object on the support container. Generally, the object may be any object on any support structure that may flex during operational conditions. For example, the object may be cargo on a support structure in the form of a platform on a back of a vehicle. The vehicle may be a road vehicle and the road vehicle may be a military road vehicle. With military road vehicles, the cargo may be a frame having seats for military personnel to be carried by the vehicle.

Usually, the movement-permitting means will be such that the vertical movement takes place in the second locking means.

The movement-permitting means may be a spring. The spring is preferably a coil spring but other types of spring may be employed.

The movement-permitting means may alternatively be a washer having a spring facility. The washer is preferably a bevel washer but other types of washer having a spring facility may be employed.

Movement-permitting means other than a spring or a washer may also be employed.

The first and second locking means may operate about a common spindle.

The first locking means may comprise a handle which is movable in a horizontal plane to move a spigot in an elongated aperture. The aperture may be a star shape or elliptical. Apertures of other shapes may be employed.

The handle is preferable movable through 90° although it may move through more or less than 90° if desired.

The second locking means may comprise a hand wheel which is manually screwed down for locking, and which is unscrewed for release.

The hand wheel may have peripheral formations for providing a hand grip.

The hand wheel may be provided with apertures for lightening the weight of the hand wheel.

The present invention also provides a support structure when provided with the locking device of the invention.

The support structure may be in the form of a flat carrying area on a vehicle. The vehicle may comprise a driving cab and a back, and the back may comprise the flat carrying area. As indicated above, the vehicle may be a road vehicle or it may alternatively be a vehicle such for example as a train or other type of vehicle.

Embodiments of the invention will now be described solely by way of example and with reference to the accompanying drawings in which:

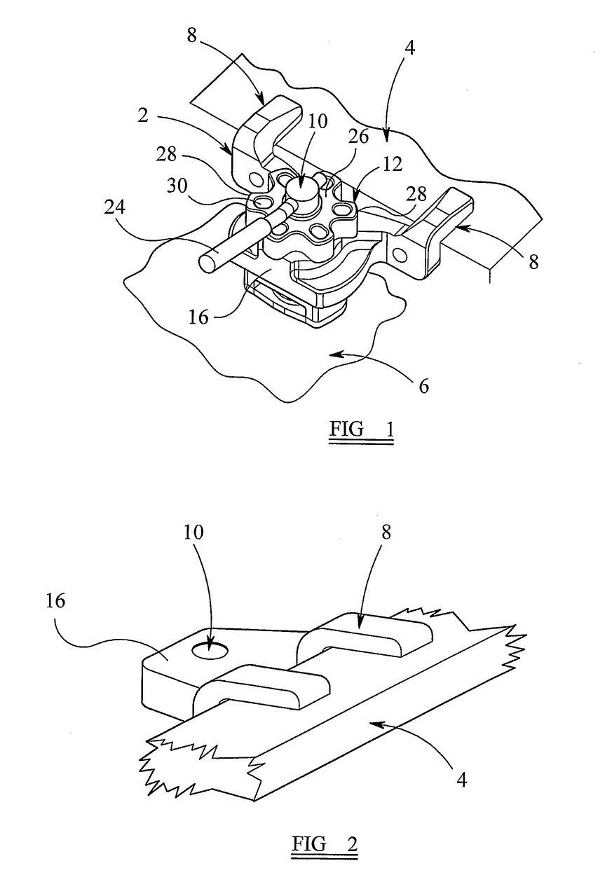

FIG. 1 is a perspective view of a locking device for locking an object on a support structure;

FIG. 2 is an alternative perspective view of part of the locking device shown in FIG. 1;

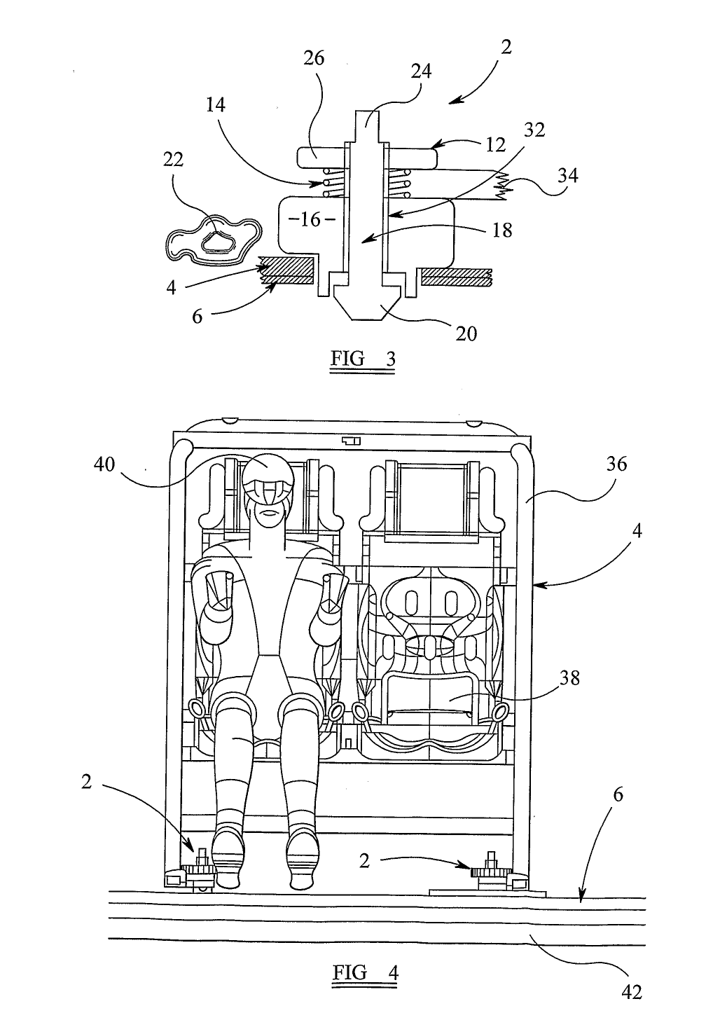

FIG. 3 is a sectional view through the locking device shown in FIG. 1;

FIG. 4 is a side view of two locking devices as shown in FIG. 1 in use locking an object on a support structure; and

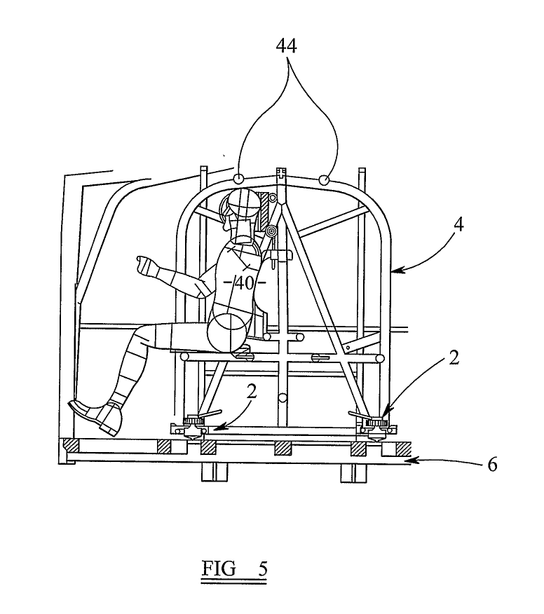

FIG. 5 is an end view of what is shown in FIG. 4.

Referring to FIGS. 1-3, there is shown a locking device 2 for locking an object 4 to a support structure 6. The locking device 2 comprises a fork arrangement 8 for engaging the object 4 as shown. The locking device 2 also comprises first locking means 10 for locking the fork arrangement 8 to the object 4 in a horizontal plane. The locking device 2 further comprises second locking means 12 for locking the fork arrangement 8 to the object 4 in a vertical plane.

The locking device 2 further comprises movement-permitting means 14 (see FIG. 3) which permits vertical movement in the locking device 2. The vertical movement is sufficient to allow the support structure 6 to flex so as to prevent the flexing of the support structure 6 acting through the locking device 2 and damaging the object 4. The vertical movement is insufficient adversely to affect secure locking of the object 4 on the support structure 6 by the locking device 2. During normal conditions, the locking device 2 will rigidly lock the object 4 to the support structure 6. Only during adverse conditions causing the support structure 6 to flex will the movement-permitting means 14 come into operation. When the movement-permitting means 14 comes into operation, it will allow the flexing of the support structure 6 to be absorbed by the locking device 2 because the vertical movement will take place in the locking device 2 and more specifically will take place in the second locking means 12. The vertical movement will be very small and it will not be sufficient adversely to affect secure locking of the object 4 on the support structure 6. Once the conditions causing the support structure 6 to flex have passed, then the movement-permitting means 14 will return to its normal position in which there will be no limited vertical movement, and the object 4 will be rigidly locked to the support structure 6, but always with the facility of the small amount of permitted vertical movement to accommodate for any flexing of the support structure 6 due to abnormal conditions.

As can be seen from FIG. 3, the movement-permitting means 14 is a coil spring. The coil spring sits between the second locking means 12 and a body part 16 of the locking device 2.

The first locking means 10 and the second locking means 12 operate about a common spindle 18. The spindle 18 terminates in a spigot 20 which moves in an elongated aperture 22. The first locking means 10 comprises a handle 24 which is movable through 90° in a horizontal plane in order to move the spigot 20 in the aperture 22. When the handle 24 is appropriately positioned, the first locking means 10 operates to lock the fork arrangement 10 to the object 4 in a horizontal plane.

After the first locking means 10 has been operated, the second locking means 12 is operated. The second locking means 12 comprises a hand wheel 26 which is manually screwed down for locking, and which is unscrewed for release. When the hand wheel 26 is screwed down, the second locking means 12 is operative to lock the fork arrangement 8 to the object 4 in a vertical plane. The hand wheel 26 has the illustrated formations 28 for providing &hand grip. The formations 28 are provided with apertures 30 in order to lighten the weight of the hand wheel 26.

When the first and the second locking means 10, 12 are in their locked condition, the movement-permitting means 14 still provides a small amount of vertical movement to accommodate flexing of the support structure 6. In addition to flexing being caused by the support structure 6 travelling over uneven terrain, flexing may also occur in other situations such for example as in the event of an accident.

As shown in FIG. 3, the spindle 18 and the body part 16 have mating coarse threads 32 for allowing speedy operation of the second locking means 12 upon rotation of the hand wheel 26. When the second locking means 12 is in its locked position, then the amount of vertical movement allowed by the movement-permitting means 14 is the gap 34 shown in FIG. 3, namely the distance between the underside of the hand wheel 26 and the upper surface of the body part 16.

Referring now to FIGS. 4 and 5, there are shown two of the locking devices 2 in operation locking an object 4 to a support structure 6. The object 4 is a frame 36 having seats 38 for persons 40. The support structure 6 is a flat rear bed on the back 42 of a military road vehicle. In the event that the road vehicle should roll over on its side in an accident, then the frame 36 provides roll over protection to the persons 40 sitting in the seats 38. Two longitudinally extending bars 44 also provide the persons 40 sitting in the seats 38 protection from hazards such as tree branches or tree trunks that may topple over onto the vehicle as it is passing through wooded areas. The. frame 36 may be a lightweight frame. Bottom seat portions of the seats 38 may be removed so that the remainder of the frame 36 can easily be fitted in position. Once fitted, the bottom portions of the seats 38 can be attached to the remainder of the frame 36. The first and/or the second locking means as shown in FIGS. 4 and 5 advantageously provide rapid release locking to aid in rapid fit and removal of the object 4 to the support structure 6.

It is to be appreciated that the embodiments of the invention described above with reference to the accompanying drawings have been given by way of example only and that modifications may be effected. Thus, for example, the fork arrangement 8 shown in the drawings has two tines. Other types of fork arrangement may be employed, for example with more than two tines. The movement-permitting means 14 may be a spring other than the illustrated coil spring. It may alternatively be a washer with a spring facility such for example as a bevel washer. The aperture 22 may be of a shape other than the illustrated star shape. Individual components shown in the drawings are not limited to use in their drawings and they may be used in other drawings and in all aspects of the invention.

1. A locking device for locking an object on a support structure, which locking device comprises a fork arrangement for engaging the object, first locking means for locking the fork arrangement to the object in a horizontal plane, second locking means for locking the fork arrangement to the object in a vertical plane, and movement-permitting means which permits vertical movement in the locking device, the vertical movement being sufficient to allow the support structure to flex so as to prevent the flexing of the support structure acting through the locking device and damaging the object, but with the vertical movement being insufficient adversely to affect secure locking of the object on the support structure by the locking device.

2. A locking device according to claim 1 in which the movement-permitting means is such that the vertical movement takes place in the second locking means.

3. A locking device according to claim 1 in which the movement-permitting means is a spring.

4. A locking device according to claim 3 in which the spring is a coil spring.

5. A locking device according to claim 1 in which the movement-permitting means is a washer having a spring facility.

6. A locking device according to claim 5 in which the washer is a bevel washer.

7. A locking device according to claim 1 in which the first and the second locking means operate about a common spindle.

8. A locking device according to claim 1 in which the first locking means comprises a handle which is movable in a horizontal plane to move a spigot in an elongated aperture.

9. A locking device according to claim 8 in which the handle is movable through 90°.

10. A locking device according to claim 1 in which the second locking means comprises a hand wheel which is manually screwed down for locking, and which is unscrewed for release.

11. A locking device according to claim 10 in which the hand wheel has peripheral formations for providing a hand grip.

12. A locking device according to claim 1 in which the hand wheel is provided with apertures for lightening the weight of the hand wheel.

13. A support structure when provided with a locking device according to claim 1.

14. A support structure according to claim 13 and in the form of a flat carrying area on a vehicle.

15. A support structure according to claim 14 in which the vehicle comprises a driving cab and a back, and in which the back comprises the flat carrying area.
